(19) United States
(12) Patent Application Publication
(10) Pub. No.: US 2009/0148732 A1
(43) Pub. Date: Jun. 11, 2009

(54) METHOD AND APPARATUS FOR WATER REMOVAL FROM A FUEL CELL SYSTEM

(75) Inventors: Paolo Forte, Toronto (CA); Antony Sabapathy, Mississauga (CA); Andrew Hill, Brampton (CA)

Correspondence Address: BERESKIN AND PARR, 40 KING STREET WEST, BOX 401, TORONTO, ON, M5H 3Y2, CA

(73) Assignee: Hydrogenics Corporation, Mississauga (CA)

(21) Appl. No.: 12/329,028

(22) Filed: Dec. 5, 2008

Related U.S. Application Data
(60) Provisional application No. 61/012,249, filed on Dec. 7, 2007.

(51) Int. Cl. H01M 8/06; H01M 8/04

(52) U.S. Cl. 429/17; 429/20

(57) ABSTRACT

A method for removal of excess process water from a fuel cell system comprises: collecting excess process water in a container; applying vibrations, e.g. ultrasonic vibrations, to at least a portion of the water to create a mist of water; and removing the mist of water from the container and expelling the mist into the ambient atmosphere. The mist may be directed to a radiator to promote evaporation. A corresponding system for removal of excess process water from a fuel cell system comprises is also provided.

### CROSS REFERENCE TO RELATED APPLICATIONS

This application claims priority under USC 119(e) from U.S. Provisional Patent Application Ser. No. 61/012,249, filed on Dec. 7, 2007, entitled “METHOD AND APPMRATUS FOR WATER REMOVAL FROM A FUEL CELL SYSTEM”.

### FIELD

The invention relates to electrochemical cells, and in particular to systems and methods for water removal from a fuel cell system.

### BACKGROUND

The following paragraphs are not an admission that anything discussed in them is prior art or part of the knowledge of persons skilled in the art.

A fuel cell is an electrochemical device that produces an electromotive force by bringing a fuel (such as hydrogen, methanol, hydrocarbons, natural gas, etc.) and an oxidant (typically air) into contact with two suitable electrodes and an electrolyte.

When hydrogen is used as the fuel and air as the oxidant, the use of fuel cells in power generation offers potential environmental benefits compared with power generation from combustion of fossil fuels or by nuclear activity because the by-products of such a reaction are heat and water.

For example, a hydrogen gas fuel is introduced at a first electrode, i.e. anode, and it reacts electrochemically in the presence of the electrolyte and catalyst to produce electrons and cations (i.e. protons if the fuel is hydrogen). The electrons are conducted from the anode to a second electrode, i.e. cathode, through an electrical circuit connected between the electrodes. Cations pass through the electrolyte to the cathode. Simultaneously, an oxidant, such as oxygen gas or air, is introduced to the cathode where the oxidant reacts electrochemically in the presence of the electrolyte and catalyst, producing anions and consuming the electrons circulated through the electrical circuit; the cations are consumed at the second electrode. The anions formed at the second electrode or cathode react with the cations to form a reaction product. The anode may alternatively be referred to as a fuel or oxidizing electrode, and the cathode may alternatively be referred to as an oxidant or reducing electrode. For an embodiment using hydrogen fuel and oxygen or air as the oxidants, the half-cell reactions at the two electrodes are, respectively, as follows:

H₂→2H⁺+2e⁻

½O₂+2H⁺+2e⁻→H₂O

The external electrical circuit withdraws electrical current and thus receives electrical power from the fuel cell. The overall fuel cell reaction produces electrical energy as shown by the sum of the separate half-cell reactions written above. Water and heat are by-products of this reaction. When other fuels and oxidants are employed, the by-products will accordingly differ.

Some examples of applications for fuel cells are distributed residential power generation and automotive power systems to reduce emission levels.

There are various known types of fuel cells. For example, proton exchange membrane (PEM) fuel cells are possible replacements for traditional power generation systems, as a PEM fuel cell (PEMFC) enables a simple, compact and robust fuel cell to be designed. Usually, PEM fuel cells are fuelled by pure hydrogen gas or by reformate gas mixtures and the by-products of the reaction are water and heat, which are environmentally friendly. A conventional PEM fuel cell usually comprises two flow field plates (bipolar plates), namely, an anode flow field plate and a cathode flow field plate, with a membrane electrode assembly (MEA) disposed therebetween. The MEA includes the actual proton exchange membrane and layers of catalyst for fuel cell reaction coated onto the membrane. Additionally, a gas diffusion medium (GDM) or gas diffusion layer (GDL) is provided between each flow field plate and the PEM to catalyst interface. The GDM or GDL facilitates the diffusion of the reactant gas, either the fuel or oxidant, to the catalyst surface of the MEA while providing electrical conductivity between each flow field plate and the PEM to catalyst interface.

In practice, fuel cells are not operated as single units. Rather, fuel cells are connected in series, stacked one on top of the other, or placed side by side. A series of fuel cells, referred to as fuel cell stack, is normally enclosed in a housing. The fuel and oxidant are directed through manifolds to the electrodes, while cooling is provided either by the reactants or by a separate cooling medium. Also within the stack are current collectors, cell-to-cell seals and insulation.

Piping and various instruments, commonly referred to as balance of plant (BOP) equipment, are externally connected to the fuel cell stack for supplying and controlling the fluid streams in the system. This equipment includes, for example, reactant gas supply and exhaust systems, humidification systems, start-up power systems, and control and regulation systems. The stack, housing, and BOP equipment make up a fuel cell unit, referred to as a fuel cell power pack or module (FCPP) or more generally as a “fuel cell system”.

### INTRODUCTION

The following introduction is intended to introduce the reader to this specification but not to define any invention. One or more inventions may reside in a combination or sub-combination of the apparatus elements or method steps described below or in other parts of this document. The inventor does not waive or disclaim his rights to any invention or inventions disclosed in this specification merely by not describing such other invention or inventions in the claims.

A common problem that has to be addressed is the removal of water generated by the chemical reactions within a fuel cell stack. Traditionally, such so called process water has been simply dumped to the ambient environment outside the fuel cell system. This may not be desirable depending upon the actual application of the fuel cell system. For example, in certain mobile applications, the expelled process water from the fuel cell system may not be deposited on the driving surface of the fuel cell vehicle. One example of this situation is a lift truck operated indoors, where water on the floor could cause the vehicle to slip or skid when driving over the water.

Therefore, there remains a need for a water removal method that is easy to use and effective.

One or more described embodiments attempt to address or ameliorate one or more shortcomings involved with current water removal techniques, or to at least provide a useful alternative to existing water removal techniques.

Some embodiments relate to a method for removal of excess process water from a fuel cell system comprising: collecting excess process water in a container; applying vibrations to at least a portion of the water to create a mist of water; and removing the mist of water from the container and expelling the mist into the ambient atmosphere.

The vibrations applied may be ultrasonic vibrations.

The mist may be contacted with at least one heat exchanger before expelling the mist into the ambient atmosphere.

Other embodiments relate to a system for removal of excess process water from a fuel cell system comprising: a fuel cell stack having a cathode exhaust and an anode exhaust; a water container connected to at least one of the cathode exhaust and the anode exhaust for collecting excess process water; a vibration unit arranged in the water container so that the vibration unit imparts vibrations to at least a portion of the collected water to produce a water mist; and a conduit to conduct at least a portion of the water mist from the water container to ambient atmosphere.

The vibration unit may produce ultrasonic vibrations.

The vibration unit may have at least one piezoelectric transducer to produce the vibrations.

The system may further comprise a heat exchanger arranged to contact at least a portion of the water mist before the mist is released into ambient atmosphere.

### BRIEF DESCRIPTION OF THE DRAWINGS

For a better understanding of the described embodiments, and to show more clearly how they may be carried into effect, reference will now be made, by way of example, to the accompanying drawings, which illustrate aspects of the described embodiments and in which:

FIG. 1 is a schematic view of a system comprising a fuel cell power module and a water removal system according to an embodiment of the invention;

FIG. 2 is a perspective view of a water removal system according to an embodiment of the invention;

FIG. 3 is an exploded partial schematic perspective view of the water removal system as shown in FIG. 2;

FIG. 4 is a perspective view of a transducer unit according to an embodiment of the invention;

FIG. 5 is a perspective view of a collecting trough according to an embodiment of the invention;

FIG. 6 is a perspective view of the collecting trough with the transducer unit inserted according to an embodiment of the invention;

FIG. 7 is a perspective view of a mist collecting unit according to an embodiment of the invention;

FIG. 8 is a perspective view of the water collecting trough with the mist collecting unit assembled according to an embodiment of the invention;

FIG. 9 is an exploded perspective view of the water removal system according to an embodiment of the invention;

FIG. 10 is a further exploded partial schematic view of a water removal system according to an embodiment of the invention;

FIG. 11 is a perspective view of the water removal system arranged to deposit mist on a radiator of a fuel cell system according to the present invention;

FIG. 12 shows that the perspective view of a variant embodiment of the water removal system of the present invention;

FIG. 13 shows a plan view of the water removal system of FIG. 13; and

FIGS. 14 and 15 shows respectively side and front views of the water removal system of FIGS. 12 and 13.

### DETAILED DESCRIPTION

Various apparatuses or methods will be described below to provide an example of an embodiment of each claimed invention. No embodiment described below limits any claimed invention and any claimed invention may cover apparatuses or methods that are not described below. The claimed inventions are not limited to apparatuses or methods having all of the features of any one apparatus or method described below or to features common to multiple or all of the apparatuses described below. It is possible that an apparatus or method described below is not an embodiment of any claimed invention. The applicant(s), inventor(s) and/or owner(s) reserve all rights in any invention disclosed in an apparatus or method described below that is not claimed in this document and do not abandon, disclaim or dedicate to the public any such invention by its disclosure in this document.

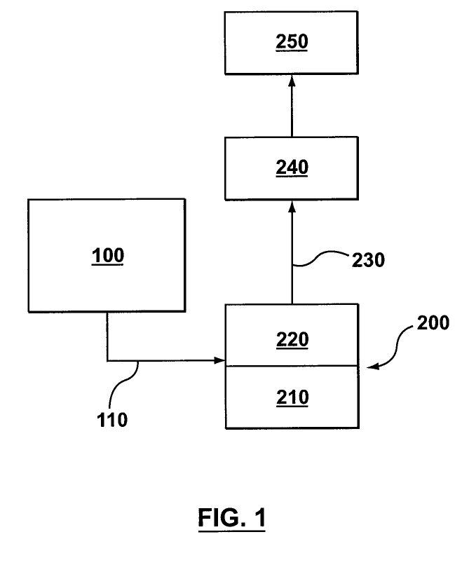

Reference is first made to FIG. 1, which illustrates a schematic view of a fuel cell system 100, which comprises a fuel cell stack (not shown) that produces water during operation. At least a portion of the produced “process water” is led, via a process water conduit 110, to a water collecting unit 200. The water collecting unit has a collecting trough 210 (with a mist generator 215, shown in FIG. 3) and a mist collecting unit 220 in fluid communication with the collecting trough. Thus, process water from the fuel cell system 100 is collected in the water collection trough 210 and at least a portion of the collected water is caused to form a mist using the mist generator 215 (FIG. 3). At least a portion of the generated mist is collected by the mist collecting unit 220 and is led away from the water collecting unit via at least one mist conducting conduit 230. The mist is either deposited onto a radiator 240 of the fuel cell system 100, and then vaporized so as to be vented out into ambient atmosphere (designated 250), or alternatively, deposited directly into ambient atmosphere, whereby it vaporizes and is dispensed into the atmosphere.

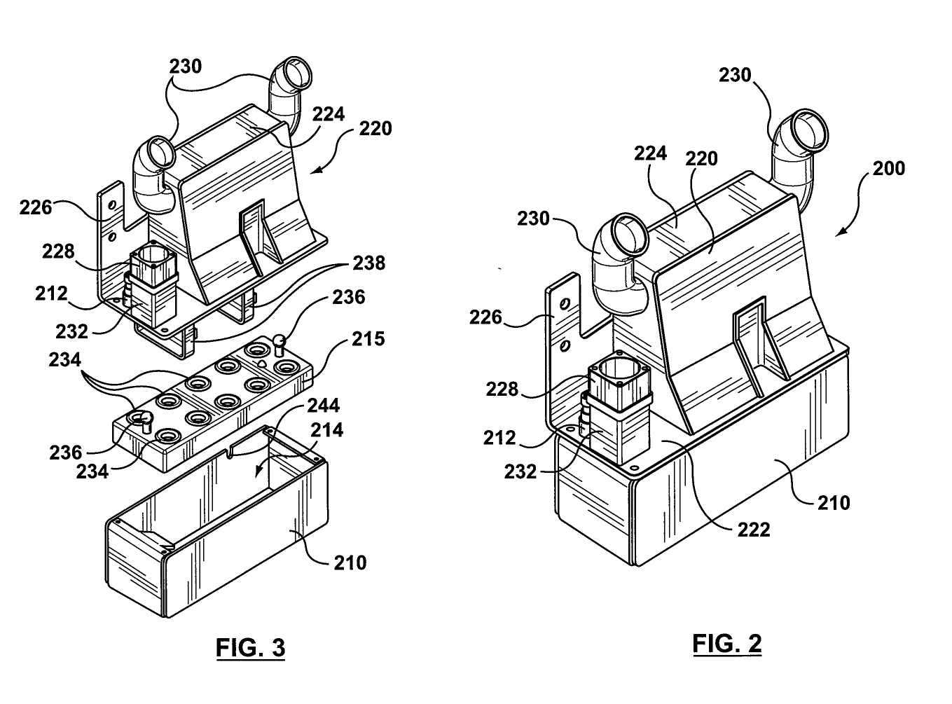

Referring now to FIG. 2, there is shown an embodiment of the water collection unit 200 with the collection trough 210 and the mist collecting unit 220. Process water is fed to the collection trough 210 via an inlet 212, which is in fluid communication with the process water conduit 110 of FIG. 1. The inlet is shown arranged on the mist collecting unit 200, but may alternatively be arranged, either instead of or as well as the connection to the mist collecting unit 220, on the collection trough 210. In the shown embodiment, the mist collecting unit 220 has a lid portion 222, which is arranged to produce a substantially water proof seal against an opening 214 (see FIG. 3) of the collection trough. Alternatively, the collection trough may have a separate lid (not shown) onto which the mist collecting unit 220 is fastened. The mist collecting unit 200 may have the mist conducting conduits 230 arranged at a portion 224 of the mist collecting unit opposite the collecting trough 210. Two mist conducting conduits are shown in this embodiment, but any number may be used. The mist collecting unit, or the collecting trough or a separate lid (not shown) for the collecting trough, may further have at least one fastening flange 226 arranged to securely fasten the water collecting unit 200 to a suitable structure (not shown), possibly a frame of the fuel cell system or similar device.

To provide a positive pressure (i.e. a pressure greater than ambient pressure) inside the water collecting unit 200, a fan 228 may be suitably arranged on the water collecting unit, for instance on an air inlet 232 arranged on the lid portion 222 of the mist collecting unit 220 (or the lid of the collecting through, if that is used). Alternatively and not shown, the fan may be arranged on the collecting trough 210 itself. The fan 228 may be powered continuously, or only during times when the mist generator 215 is operated. Additionally, the fan may be operated for a pre-set time period longer than the mist generator, so that the fan is switched on when the mist generator is switched on but, when the mist generator is switched off, the fan is still operated for the pre-set time period. Alternatively and not shown, other than the fan 228 or in addition to the fan 228, pressure created by the cathode exhaust of the FCPP may be piped to the water collecting unit 200 and utilized to provide a positive pressure.

Shown in FIG. 3 is an embodiment of the mist generator 215. The mist generator 215 of this embodiment has a plurality of piezoelectric transducers 234, the number of transducers being dictated by the amount of water that is to be turned into mist per time unit. The transducers are connected to a power supply, not shown, which may be the electric output of the fuel cell system or another source of electricity. Since the transducers do not work optimally unless there is a certain level of water above the transducers, at least one water level sensor 236 is arranged and connected so that the power to the transducers is cut off when the water level measured by the level sensor(s) is below a certain pre-set level.

Further, at least one baffle 238 may be arranged in the water collecting unit 200, to prevent the water in the collecting trough 210 from moving too much (i.e. to keep a certain level of water above each transducer at all times, if possible). The at least one baffle 238 is used to deflect air from the fan 228 away from the water and transducers 234 directly below the fan 228 since, without at least one baffle 238, the water level reading may not be accurate. The at least one baffle 238 provides for a more even air flow, enabling air from the fan 228 to expel mist in a more controlled manner. In the embodiment shown, there are two baffles 238 and they may serve an additional purpose of being alignment clamps to hold the mist generator 215 in place inside the collecting trough 210 when the water collecting unit 200 is assembled.

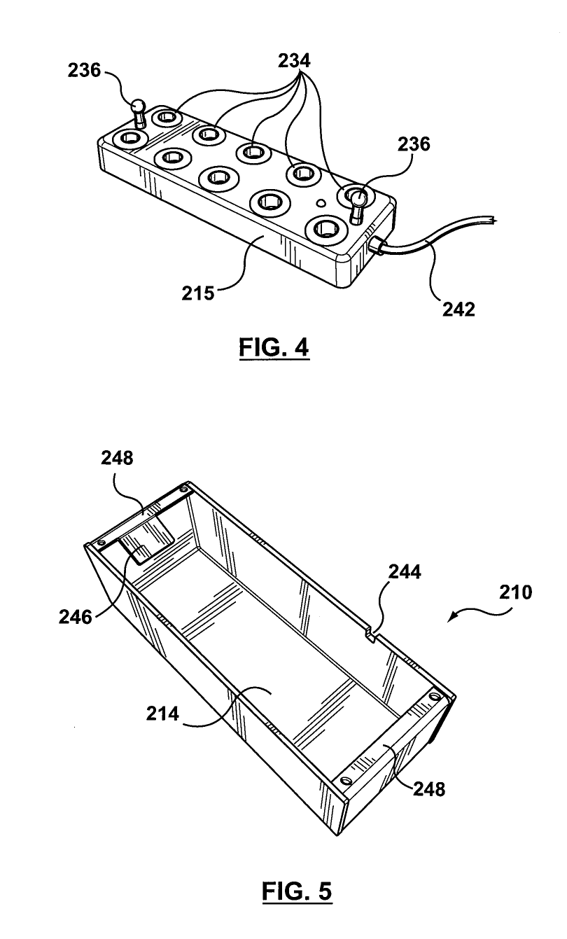

FIG. 4 shows the embodiment of the mist generator 215 as already shown in FIG. 3. In the figure is also visible a power connecting cord 242, which supplies electric power to each transducer. As mentioned above, the power may be taken from the fuel cell system or elsewhere. A suitable notch 244 (see FIG. 3) may be arranged in the collection trough 210 to receive the cord 242 (or in the lid portion 222 of the mist collecting unit 220, or the lid of the collecting unit, if used, neither is shown in the figures).

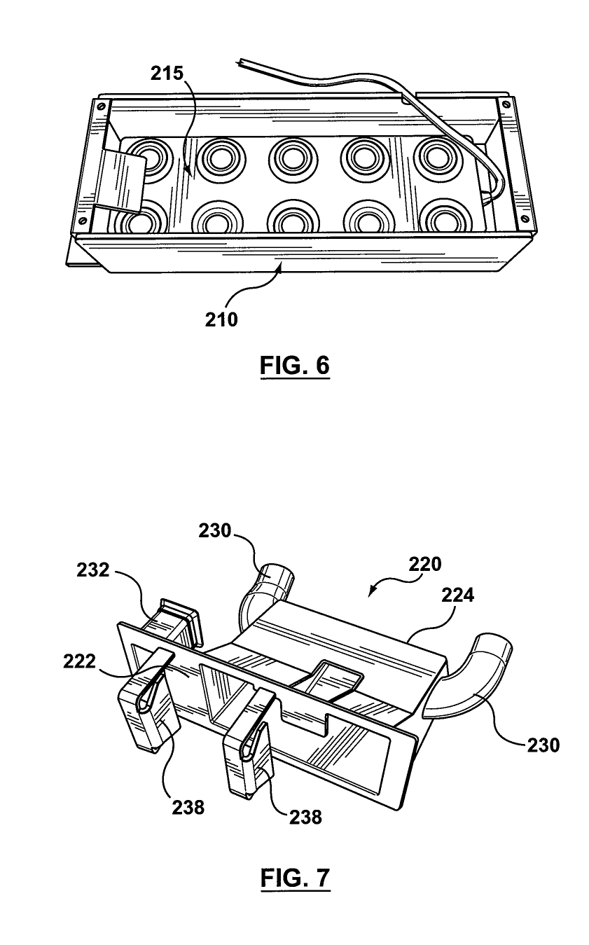

FIG. 5 shows the embodiment of the collecting trough 210 also shown in FIG. 3. In the figure is visible a hold-down protrusion 246, which holds one end of the mist generator when the mist generator is inserted into the collecting trough, as shown in FIG. 6. Further, suitable fastening elements 248 are arranged to facilitate fastening the mist collecting unit to the collecting trough.

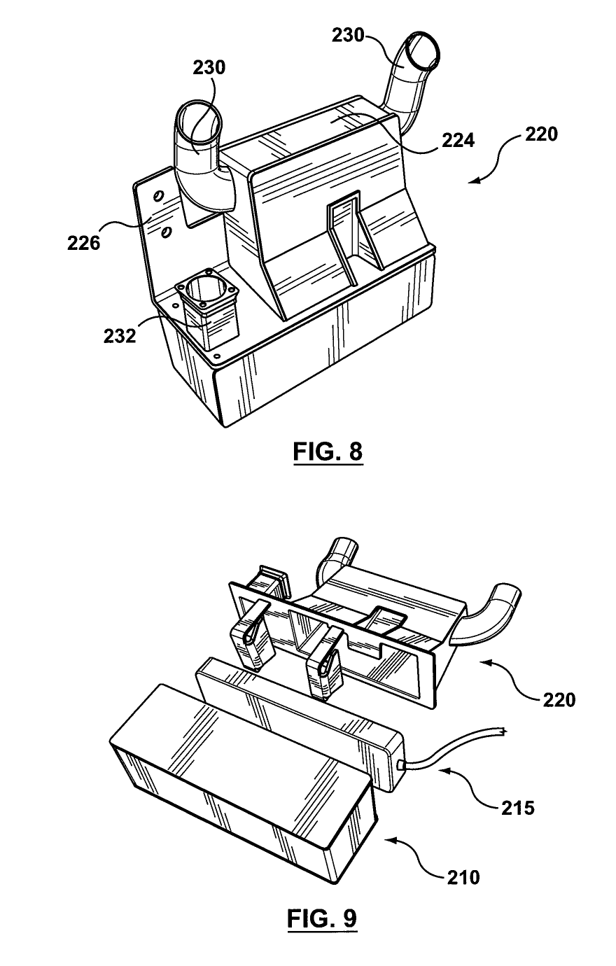

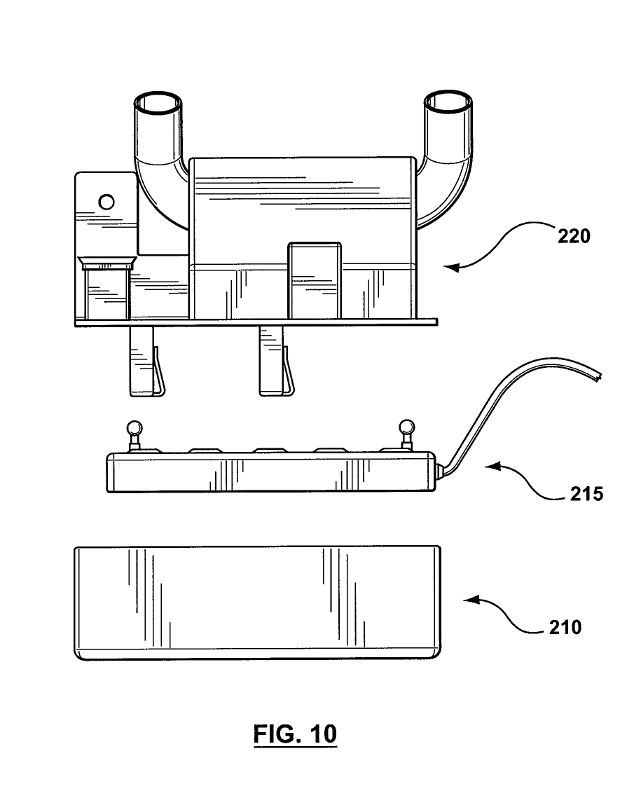

FIG. 7 shows the embodiment of the mist collecting unit 220 also shown in FIGS. 2 and 3. The figure shows the hollow inside of the unit, which acts as a “smoke stack” to conduct generated mist away from the collecting trough and out via the mist conducting conduits 230. FIG. 8 shows the mist collecting unit from another angle. FIGS. 9 and 10 show how the collecting trough 210, the mist generator 215 and the mist collecting unit 220 are assembled.

Instead of venting the mist directly to ambient atmosphere, the mist may be utilized to remove heat from a radiator 240 (or any type of heat exchange apparatus). The mist conducting conduits 230 are in this case directed towards a surface of the radiator, so that expelled mist comes into contact with at least one surface of the radiator so that the water in the mist may remove heat from the radiator when the water is vaporized from the radiator surface(s).

The material used in the water collecting unit 200 must be water resistant, and in general will need to be resistant to deionized water. Thus, stainless steel, different plastics or other suitable materials are considered. The collecting trough and the mist collecting unit may be made as one piece with an opening in the collecting trough for inserting the mist generator, this embodiment is not shown. The mist generator could then be sealingly fastened in the opening, for example by using water compatible glue.

If a ventilation device is already present in the fuel cell system and/or vehicle, at least a portion of the air stream generated by the ventilation device may be used to ventilate the generated mist out from the water collecting unit according to the invention. Thus, the additional fan would not be used in this embodiment. However, for some embodiments, it may still be desirable to retain the fan 228, to ensure that generated mist is driven out through the conduit 230, for entrainment in to an airflow from another source.

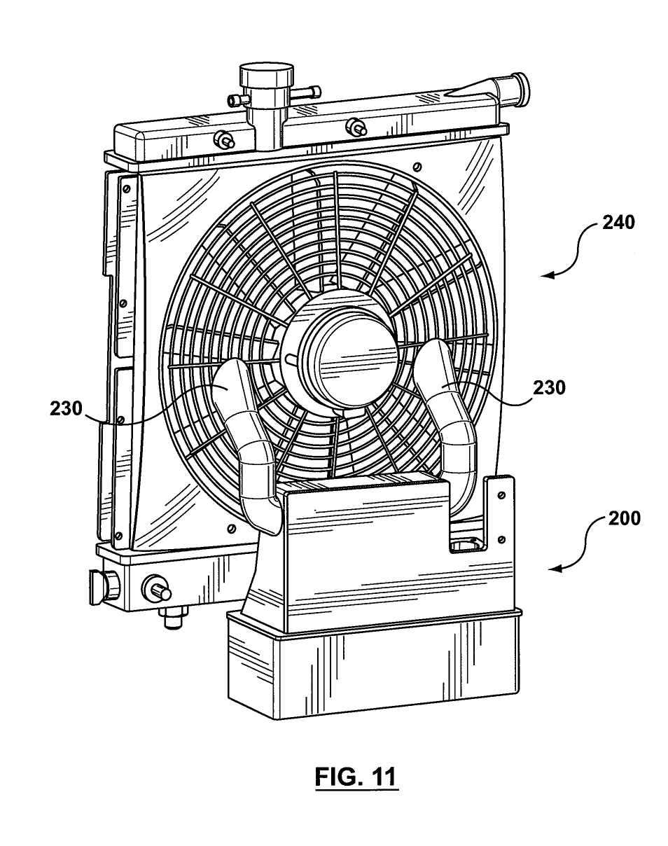

While FIG. 11 shows a radiator assembly that is largely conventional, it will be understood that, for some applications, an alternative radiator configuration can be used. To ensure that the mist generated impinges directly on the fins etc. of the radiator, the conduit 230 can be arranged to direct the mist directly on the radiator surfaces. Thus, the outlets of the ducts 230 could be arranged inside any protective grill of the radiator 240 and also downstream from any fan of the radiator, so as to ensure that the mist does not impinge on the blades of the fan.

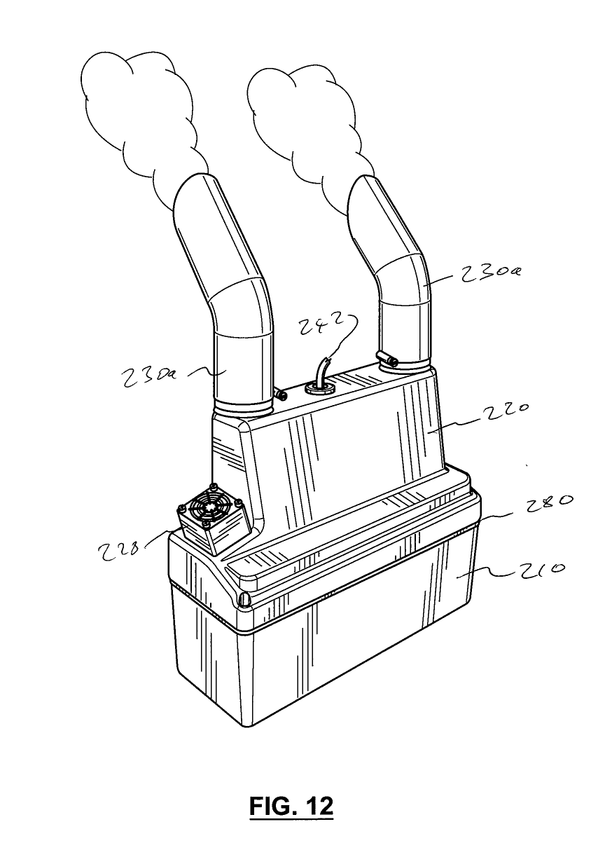

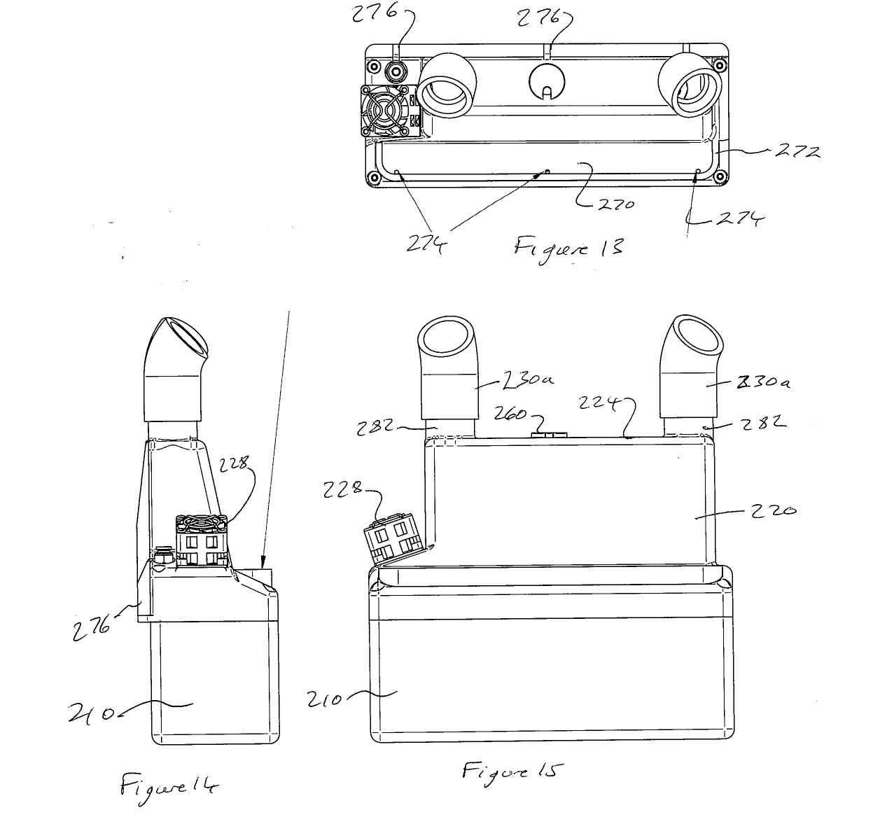

Referring to FIGS. 12-15, these show a variant embodiment of the water removal system of the present invention. In these Figures, like components are given the same reference view as in FIGS. 1-11. For simplicity and brevity the description of these components is not repeated.

It is to be recognized that, for some fuel cell applications, the temperature differential available for cooling can be relatively low. Thus, PEM (Proton Exchange Membrane) type fuel cells typically operate in a temperature range of 65° C., so that the temperature differential with respect to ambient is relatively small. Consequently, radiators may need to be quite large in order to dissipate the heat generated, as no large temperature differential is available. For this reason, the use of mist from generated water can be useful in promoting heat transfer for the radiator, thereby keeping radiator sizes reasonable.

Related to this, dispensing of the water in the form of mist onto the radiator can be coordinated with operation of the fuel cell. For some applications, it may be that, for example, on start up, and at low power levels, a radiator can adequately handle the heat discharge requirements. At higher power levels, it may then be desirable to provide the misting, to improve the performance of the radiator. For such applications, operation of the unit generating the mist can be coordinated or controlled in dependence upon operation of the fuel cell system or power module, so that the additional cooling provided by the mist is coordinated with the demands placed on the radiator.

Thus on initial start up and/or at low power levels, generated water is retained and is not formed into mist; when high power is required, then the water is used to generate mist to promote cooling. For such applications, control may also be dependent on the level of water in the mist-collecting unit 220. Thus, if the water level exceeds a certain set level, this can be discharged as mist in any event, whatever the current alarms on the radiator, to prevent excessive water levels being reached.

The overall construction of this variant embodiment is similar to that of the first embodiment of the present invention. In this embodiment the collection trough or container 210 and the mist collecting unit 220 are injection molded in ABS plastic.

Such a manufacturing technique, unknown names, gives greater flexibility in choice of the design and shape of individual components. For example, reinforcing ribs indicated at 276 maybe provided.

Additionally, to seal the collection trough 210 and the mist collecting unit 220, an O-ring seal 280 is provided, which may or may not be visible (shown as visible in FIG. 12).

In this embodiment, the conduit for the mist are indicated at 230a, and are provided in the form of silicon hoses that are shaped to the desired profile. The conduits 230a are held by suitable clamping rings to short outlet projections 282 at the top of the mist collecting unit 220.

On top of the mist collecting unit 220, an opening is provided for the power cord 242, for the transducer 234, and this is provided with a suitably sealed connection.

It has been found that, in use mist directed towards, for example, the radiator 240 may not all be evaporated or otherwise dispersed in the ambient air. Some of the mist may condense and droplets may run down onto the exterior of the water removal system. To address such condensation, a drip tray is formed, by suitably shaping the molding at the top of the mist collecting unit 220. The drip tray is indicated at 270, and includes an outer ledge 272 to collect condensate. Small openings 274 are provided at the edge of the drip tray, at the lowest point thereof, to permit water to drain down into the collection trough 210. All these openings 274 may permit some air to escape from within the device, but the air pressure is relatively low and any air loss will be small, as in any event the mist conducting conduit 230A have a large cross-section part.

While the above description provides example embodiments, it will be appreciated that some features and/or functions are susceptible to modification and change without departing from the fair spirit and principles of operation of the described embodiments. Accordingly, what has been described is merely illustrative of the application of the described embodiments and numerous modifications and variations are possible in light of the above teachings.

1. A method for removal of excess process water from a fuel cell system comprising:
a) collecting excess process water in a container;
b) applying vibrations to at least a portion of the water to create a mist of water;
c) removing the mist of water from the container and expelling the mist into the ambient atmosphere.

2. The method of claim 1, wherein the vibrations applied are ultrasonic vibrations.

3. The method of claims 1 or 2, wherein step c) comprises contacting the mist with at least one heat exchanger to promote evaporation of the mist into the ambient atmosphere.

4. The method as claimed in claims 1 or 2, including providing for collection of unwanted condensate formed from the mist and retaining the condensate to the container for recirculation as mist.

5. A system for removal of excess process water from a fuel cell system comprising:
a) a fuel cell stack having a cathode exhaust and an anode exhaust;
b) a water container connected to at least one of the cathode exhaust and the anode exhaust for collecting excess process water;
c) a vibration unit arranged in the water container so that the vibration unit imparts vibrations to at least a portion of the collected water to produce a water mist; and
d) a conduit to conduct at least a portion of the water mist from the water container to ambient atmosphere.

6. The system of claim 5, wherein the vibration unit produces ultrasonic vibrations.

7. The system of claim 6, wherein the vibration unit has at least one piezoelectric transducer to produce the vibrations.

8. The system of claims 6 or 7 further comprising a heat exchanger arranged to contact at least a portion of the water mist to promote vaporization of the mist into ambient atmosphere.

9. The system of claims 6, including one of a fan and other device for passing air into the water container and out through the conduit, entrain water mist therein.

10. The system of claim 9, including at least one baffle within the water container, to control airflow within the container.

11. The system of claim 9, including at least two conduits to conduct the water mist from the water container.

12. The system of claim 9, wherein the system includes a collection trough providing the water container and a mist collecting unit, and wherein the collection trough and the mist collecting unit are molded from a plastic material.

13. The system of claim 12, wherein the fan is mounted to the mist collecting unit.

14. The system of claim 13, including an O-ring seal between the collection trough and the mist collecting unit.

15. The system of claim 14, wherein the mist collecting unit defines a drip tray for collecting condensate on an exterior thereof.

16. The system of claim 15, wherein the mist collecting unit includes openings, permitting collected condensate to drain down into the collection trough.

17. The system of claim 15 or 16 including at least two conduits, wherein in each conduit comprises a hose mounted to the mist collecting unit.

18. The system of claim 17, wherein in each hose comprises a silicone hose
